(19) United States
(12) Patent Application Publication
(10) Pub. No.: US 2025/0191471 A1
(43) Pub. Date: Jun. 12, 2025

(54) METHOD AND SYSTEM FOR MARSHALING DOWNLINK COVERAGE

(71) Applicant: Ford Global Technologies, LLC, Dearborn, MI (US)

(72) Inventors: Syed Amaar Ahmad, Canton, MI (US); Krishna Bandi, Novi, MI (US); Joseph Andreas Urhahne, Pulheim (DE)

(73) Assignee: Ford Global Technologies, LLC, Dearborn, MI (US)

(21) Appl. No.: 18/604,450

(22) Filed: Mar. 13, 2024

Related U.S. Application Data
(60) Provisional application No. 63/606,643, filed on Dec. 6, 2023.

(51) Int. Cl. G08G 1/00; G08G 1/0967; H04W 4/44; H04W 28/06

(52) U.S. Cl. CPC G08G 1/20; G08G 1/096783; H04W 4/44; H04W 28/06

(57) ABSTRACT

A method of segmenting a plurality of marshaled vehicles into one or more marshaling groups based on a distance each of the marshaled vehicles are from a respective road-side unit of one or more road-side units, fragmenting a message into a plurality of messages based on one or more transmission criteria, and transmitting the plurality of fragmented messages to each marshaled vehicle of the plurality of marshaled vehicles.

### CROSS-REFERENCE TO RELATED APPLICATION

This application claims the benefit of and priority to U.S. Provisional Application No. 63/606,643 filed on Dec. 6, 2023, and titled “METHOD AND SYSTEM FOR MARSHALING DOWNLINK COVERAGE”, the contents of which are incorporated herein by reference in its entirety.

### FIELD

The present disclosure relates to marshaling one or more autonomous vehicles. More specifically, the present disclosure relates to optimizing marshaling groups and downlink messages to allow for enhanced connectivity between an infrastructure system and the one or more autonomous vehicles.

### BACKGROUND

The statements in this section merely provide background information related to the present disclosure and may not constitute prior art.

Automated vehicle marshaling (AVM) technology enables automated vehicles coming end-of-line in a manufacturing plant, depot, or parking facility to be wirelessly controlled and guided to a parking facility via wireless guidance by a sensing infrastructure controller that constantly monitors and detects the automated vehicles. However, with wireless communication, there is a possibility of loss of communication of data packets between the automated vehicle and the sensing infrastructure controller. The size of the packets sent by the sensing infrastructure controller to the automated vehicles will also increase if there are more marshaled automated vehicles and/or when an automated vehicle requires more waypoints for certain (e.g., sharper) maneuvers. A larger packet size is more prone to loss of packets, especially as the distance between the automated vehicle and the sensing infrastructure controller increases.

Loss of packets from the sensing infrastructure controller can cause disruption in the marshaling and reduce traffic throughput of automated vehicles maneuvering inside the AVM facility. An automated vehicle that loses connectivity with the sensing infrastructure must then carry out an evasive event or action and the sensing infrastructure controller must also adjust the maneuvers of the remaining connected automated vehicles. The present disclose addresses these and other issues related to the marshaling of one or more autonomous vehicles.

### SUMMARY

This section provides a general summary of the disclosure and is not a comprehensive disclosure of its full scope or all of its features.

The present disclosure provides a method comprising: segmenting a plurality of marshaled vehicles into one or more marshaling groups based on a distance each of the marshaled vehicles are from a respective road-side unit of one or more road-side units; fragmenting a message into a plurality of fragmented messages based on one or more transmission criteria; and transmitting the plurality of fragmented messages to each marshaled vehicle of the plurality of marshaled vehicles, wherein a first marshaling group of the one or more marshaling groups receives a fragmented message that is different than a fragmented message received by a second marshaling group of the one or more marshaling groups; wherein the plurality of marshaled vehicles is segmented, based at least in part on, a number of waypoints associated with each of the marshaled vehicles; wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof; further comprising: updating the segmentation of the plurality of marshaled vehicles based on an updated distance each of the marshaled vehicles are from the respective road-side unit; wherein the fragmentation of the message further comprises: determining a number of bytes required to define one or more maneuver commands for each marshaled vehicle of the plurality of marshaled vehicles; wherein the segmentation of the plurality of marshaled vehicles further comprises: generating one or more marshaling group combinations based on the determination of the number of bytes; and wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.

The present disclosure provides a system comprising: an infrastructure system configured to: segment a plurality of marshaled vehicles into one or more marshaling groups based on a distance each of the marshaled vehicles are from a respective road-side unit of one or more road-side units, fragment a message into a plurality of fragmented messages based on one or more transmission criteria, and transmit the plurality of fragmented messages to each marshaled vehicle of the plurality of marshaled vehicles; a first marshaling group configured to: receive a fragmented message of the plurality of fragmented messages; and a second marshaling group configured to: receive a fragmented message of the plurality of fragmented messages that is different than the fragmented message received by the first marshaling group; wherein the plurality of marshaled vehicles is segmented, based at least in part on, a number of waypoints associated with each of the marshaled vehicles; wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof; wherein the infrastructure system is further configured to: update the segmentation of the plurality of marshaled vehicles based on an updated distance each of the marshaled vehicles are from the respective road-side unit; wherein the infrastructure system configured to fragment the message is further configured to: determine a number of bytes required to define one or more maneuver commands for each marshaled vehicle of the plurality of marshaled vehicles; wherein the infrastructure system configured to segment the plurality of marshaled vehicles is further configured to: generate one or more marshaling group combinations based on the determination of the number of bytes; and wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.

The present disclosure provides one or more non-transitory computer-readable media storing processor-executable instructions that, when executed by at least one processor, cause the at least one processor to: segment a plurality of marshaled vehicles into one or more marshaling groups based on a distance each of the marshaled vehicles are from a respective road-side unit of one or more road-side units and based on a number of waypoints associated with each of the marshaled vehicles; fragment a message into a plurality of fragmented messages based on one or more transmission criteria; and transmit the plurality of fragmented messages to each marshaled vehicle of the plurality of marshaled vehicles, wherein a first marshaling group of the one or more marshaling groups receives a fragmented message that is different than a fragmented message received by a second marshaling group of the one or more marshaling groups; wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof; wherein the at least one processor is further caused to: update the segmentation of the plurality of marshaled vehicles based on an updated distance each of the marshaled vehicles are from the respective road-side unit; wherein the processor-executable instructions that, when executed by the at least one processor, fragment the message, further causes the at least one processor to: determine a number of bytes required to define one or more maneuver commands for each marshaled vehicle of the plurality of marshaled vehicles; wherein the processor-executable instructions that, when executed by the at least one processor, segment the plurality of marshaled vehicles, further causes the at least one processor to: generate one or more marshaling group combinations based on the determination of the number of bytes; and wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for autonomous vehicle marshaling in accordance with various implementations;

FIG. 2 illustrates a graph depicting communication ranges of varying packet sizes in accordance with various implementations;

FIGS. 3A-3C illustrate the grouping of one or more autonomous vehicles in accordance with various implementations; and

FIG. 4 is a flowchart illustrating an example method for marshaling the one or more autonomous vehicles illustrated in FIGS. 3A-3C and in accordance with various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a means for marshaling one or more autonomous vehicles that in one or more examples optimizes downlink communication from an infrastructure system to the one or more autonomous vehicles by enhancing wireless reliability using smaller packet sizes, if possible, as well as placing road-side units (RSUs) in optimized locations to minimize possible connectivity outages. For example, a larger downlink packet is divided into multiple smaller packets with utility considerations to the one or more autonomous vehicles, as well as dividing or grouping the one or more autonomous vehicles into complementary sets to be handled by individual RSUs. The benefits of utilizing one or more herein described marshaling methods include less likelihood of disruption of marshaling maneuvers and smoother automated traffic operation in a large manufacturing plant and/or parking lot, for example.

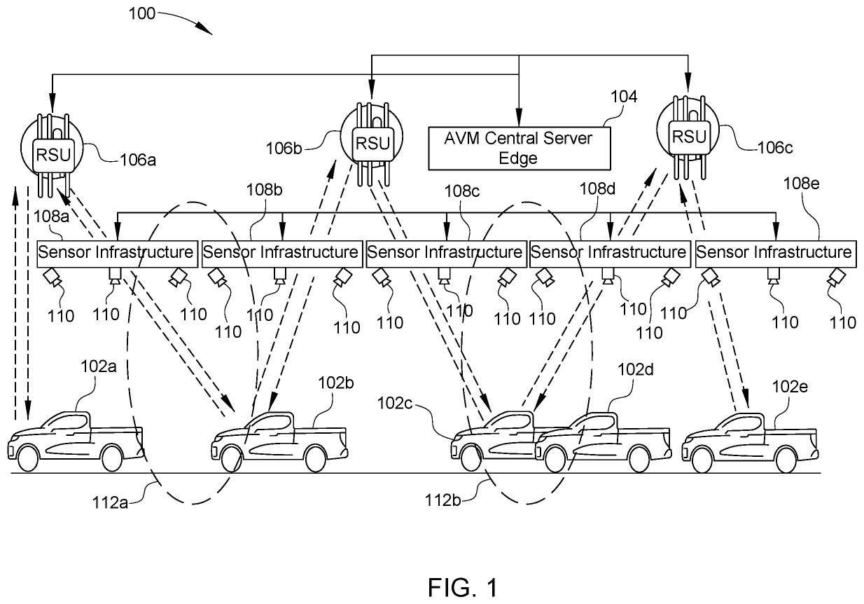

FIG. 1 illustrates a marshaling system 100 that facilitates an engagement of one or more autonomous vehicles 102a-102e with an infrastructure system (not shown). Generally, an automated vehicle marshaling (AVM) central server edge 104 (e.g., an edge processor) is connected to one or more RSUs 106a-106c. For example, the AVM central server edge 104 is connected to the one or more RSUs 106a-106c by a wireless means, a wired means, or a combination thereof. The AVM central server edge 104 is also connected to one or more sensor infrastructures 108a-108e. For example, the AVM central server edge 104 is connected to the one or more sensor infrastructures 108a-108e by a wireless means, a wired means, or a combination thereof.

The AVM central server edge 104 is configured to utilize sensor data received from the one or more sensor infrastructures 108a-108e to determine a location of any of the one or more autonomous vehicles 102a-102e. Each of the one or more sensor infrastructures 108a-108e include a set of infrastructure sensors 110 such as, for example, a two-dimensional (2D) camera, a three-dimensional (3D) camera, an infrared sensor, a radar scanner, a laser scanner, a light detection and ranging (LIDAR) sensor, an ultrasonic sensor, among others. The set of infrastructure sensors 110 monitor the movement of each of the one or more autonomous vehicles 102a-102e as the one or more autonomous vehicles 102a-102e move through an environment (e.g., a manufacturing environment or a parking lot).

In one or more examples, the sensor data is generated based on the type of monitoring being performed by the set of infrastructure sensors 110 (e.g., the movement of each of the one or more autonomous vehicles 102a-102e or the environment itself). In one form, the one or more sensor infrastructures 108a-108e provide pose, routing, and obstacle data of the environment to the AVM central server edge 104.

The AVM central server edge 104 is further configured to utilize the one or more RSUs 106a-106c to facilitate communication between the AVM central server edge 104 and any of the one or more autonomous vehicles 102a-102e. The one or more RSUs 106a-106c are equipped with a cellular vehicle-to-infrastructure communication system (referred to as “CV2X systems”). As an example, the one or more RSUs 106a-106c are equipped with a PC5-based CV2X that employs radio frequency sidelink communication for low latency vehicle sensor connectivity.

Each of the one or more RSUs 106a-106c are configured to receive one or more infrastructure-side data packets from the AVM central server edge 104. Generally, each of the one or more RSUs 106a-106c can include various components for performing the operations described herein, such as, but not limited to, transceivers, processor circuits, memory circuits, routers, and/or input/output interface hardware. For example, the one or more infrastructure-side data packets can include one or more instructions, one or more signals, or a combination thereof. Each of the one or more RSUs 106a-106c are further configured to broadcast the one or more infrastructure-side data packets to any of the one or more autonomous vehicles 102a-102e within range of the one or more RSUs 106a-106c. As another example, the one or more infrastructure-side data packets are generated from one or more infrastructure marshaling messages (IMMs) (i.e., marshaling infrastructure messages). As another example, each of the one or more RSUs 106a-106c are configured to broadcast the one or more infrastructure-side data packets via one or more wireless communication protocols, such as a CV2X protocol, a private and/or public cellular protocol, a Wi-Fi protocol, a long range (LoRA) signal protocol, a Bluetooth protocol, and/or a UWB protocol.

Each of the one or more RSUs 106a-106c are further configured to receive one or more vehicle-side data packets including one or more vehicle marshaling messages (VMMs) (i.e., marshaling vehicle messages) from any of the one or more autonomous vehicles 102a-102e. Each of the one or more RSUs 106a-106c are additionally configured to forward the one or more vehicle-side data packets to the AVM central server edge 104.

Further illustrated in FIG. 1 is a duality of RSU network areas 112a, 112b. it is understood that there may be any number of RSU network areas. Each of the duality of RSU network areas 112a, 112b provide network coverage that correspond to at least a midpoint between each of the one or more RSUs 106a-106c. For example, the RSU network area 112a provides network coverage that corresponds to at least a midpoint between the RSU 106a and the RSU 106b. As another example, the RSU network area 112b provide network coverage that corresponds to at least a midpoint between the RSU 106c and the RSU 106a.

However, each of the duality of RSU network areas 112a, 112b aid in supporting network coverage to each of the one or more autonomous vehicles 102a-102e. For example, the RSU network area 112b represents an overlapping hand-off area that provides network coverage as an autonomous vehicle of the one or more autonomous vehicles 102a-102e travels away from the RSU 106c and toward the RSU 106b. As an example, in the instance wherein the autonomous vehicle of the one or more autonomous vehicles 102a-102e travels away from the RSU 106c and toward the RSU 106b, both RSUs 106b, 106c send the one or more infrastructure-side data packets to the autonomous vehicle of the one or more autonomous vehicles 102a-102e for optimal coverage.

As another example, the RSU network area 112a represents an overlapping hand-off area that provides network coverage as an autonomous vehicle of the one or more autonomous vehicles 102a-102e travels away from the RSU 106b and toward the RSU 106a. As an additional example, in the instance wherein the autonomous vehicle of the one or more autonomous vehicles 102a-102e travels away from the RSU 106b and toward the RSU 106a, both RSUs 106a, 106b send the one or more infrastructure-side data packets to the autonomous vehicle of the one or more autonomous vehicles 102a-102e for optimal coverage. As yet another example, either of the RSU pairs 106b, 106c and/or 106a, 106b complement the respective network coverage each of the one or more RSUs 106a-106c provide to any of the one or more autonomous vehicles 102a-102e. Additionally, each of the one or more autonomous vehicles 102a-102e are configured to send the one or more vehicle-side data packets back to the one or more RSUs 106a-106c.

The AVM central server edge 104 is additionally configured to determine a precise location of any of the one or more autonomous vehicles 102a-102e. For example, the AVM central server edge 104 can determine a precise location of any of the one or more autonomous vehicles 102a-102e at least based on the sensor data and/or the one or more vehicle-side data packets. It is understood that each of the one or more vehicle-side data packets can include a received signal strength indicator (RSSI) associated with the originating autonomous vehicle of the one or more autonomous vehicles 102a-102e. The AVM central server edge 104 is further configured to determine a closest (e.g., in distance) RSU of the one or more RSUs 106a-106c to any of the one or more autonomous vehicles 102a-102e. For example, the AVM central server edge 104 can determine a closest RSU of the one or more RSUs 106a-106c to any of the one or more autonomous vehicles 102a-102e at least based on the sensor data and/or the one or more vehicle-side data packets.

The AVM central server edge 104 is configured to utilize smaller data packet sizes (e.g., a plurality of fragmented messages divided from a singular data packet) to enhance reception of the one or more infrastructure-side data packets by the one or more autonomous vehicles 102a-102e. For example, an enhancement to the reception of the one or more infrastructure-side data packets by the one or more autonomous vehicles 102a-102e corresponds to an enhanced downlink coverage in the respective network coverage each of the one or more RSUs 106a-106c provide to any of the one or more autonomous vehicles 102a-102e.

The AVM central server edge 104 is further configured to fragment (i.e., to divide) the data packet of the one or more infrastructure-side data packets broadcasted to each of the one or more autonomous vehicles 102a-102e. It is understood that the size of the infrastructure-side data packets is based on how many autonomous vehicles the AVM central server edge 104 is marshaling at any given time and/or a number of commanded trajectory waypoints. For example, the AVM central server edge 104 fragments the data packet of the one or more infrastructure-side data packets based on how many autonomous vehicles the AVM central server edge 104 is marshaling at any given time and/or a number of commanded trajectory waypoints associated with each of the autonomous vehicles. The AVM central server edge 104 is additionally configured to determine an optimal fragmentation of a data packet of the one or more infrastructure-side data packets based at least on a commanded vehicle maneuver associated with each of the autonomous vehicles.

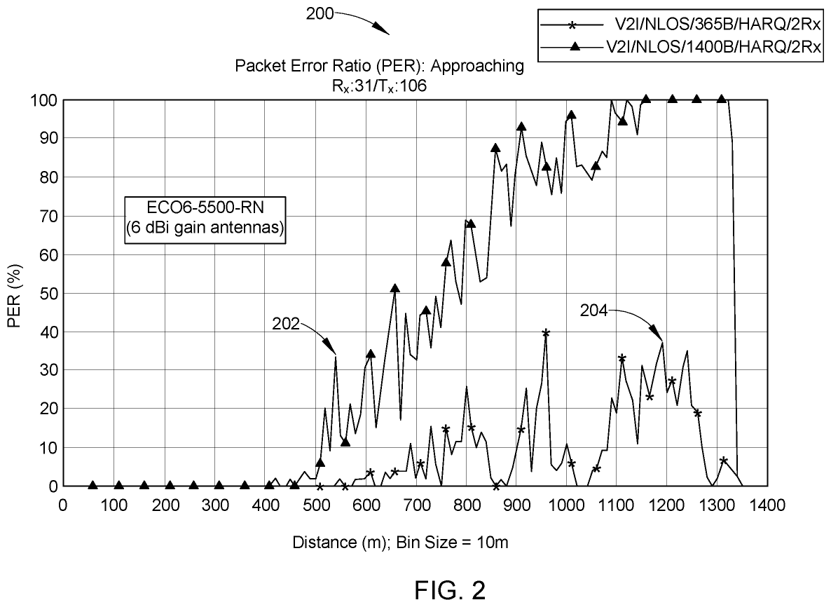

FIG. 2 is a graph 200 illustrating a packet error ratio wherein the x-axis is a communication range between a transmitter (e.g., the infrastructure system) and the one or more autonomous vehicles 102a-102e while the y-axis is a packet error ratio. A first measurement reading 202 depicts a data packet with 1400 bytes while the second measurement reading 204 depicts a data packet with 365 bytes. The graph 200 shows that at approximately 500 m, the loss of data packets begins to occur relative to both the first measurement reading 202 and the second measurement reading 204. For example, the higher packet error ratio associated with the first measurement reading 202 and/or the second measurement reading 204 corresponds to a loss of data packets. Thus, based on the results of the graph 200, as can be seen, the second measurement reading 204 indicates an allowance for a more reliable communication (e.g., less data packets are lost), compared to the first measurement reading 202. Additionally, based on the results of the graph 200, the second measurement reading 204 indicates an allowance for a more reliable communication over a larger distance in comparison to the first measurement reading 202.

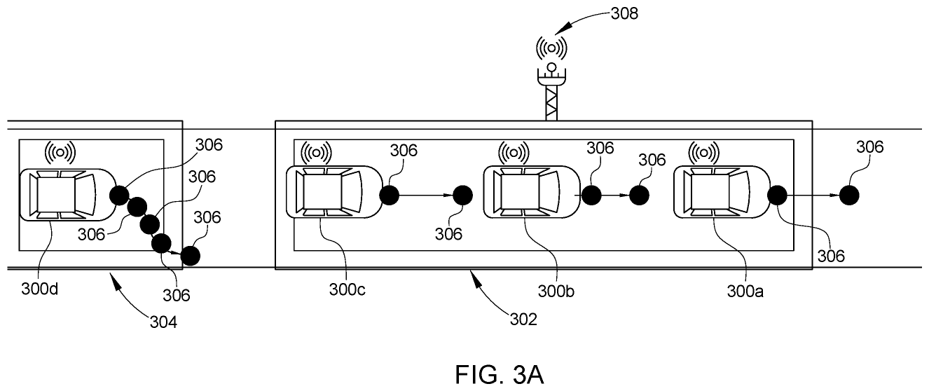

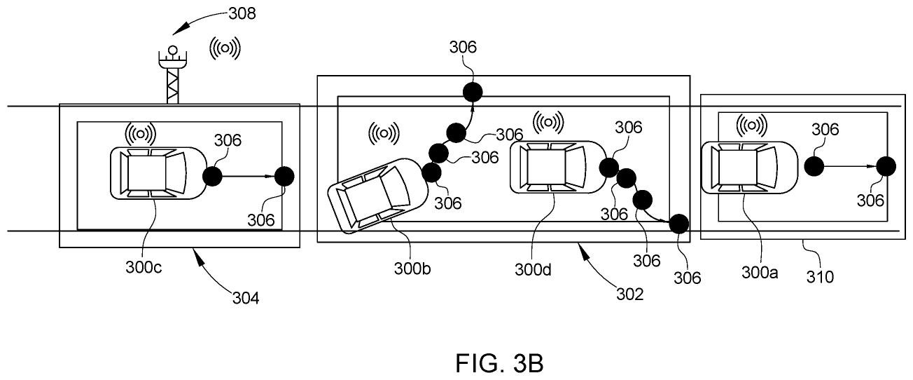

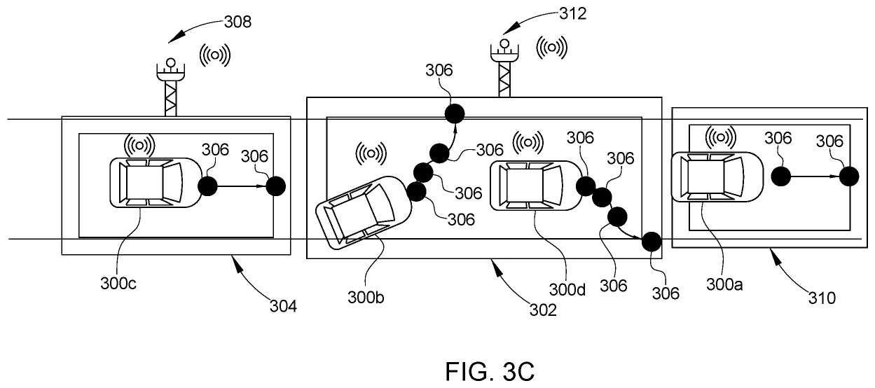

FIG. 3A is illustrative of a first example embodiment wherein the infrastructure system is configured to split one or more autonomous vehicles 300a-300d into multiple communication groups (e.g., a first group 302 and a second group 304). For example, the infrastructure system is configured to split the one or more autonomous vehicles 300a-300d into multiple groups at any transmission interval. In this particular example, a single first RSU 308 broadcasts a unique IMM tailored to each group of the multiple groups. As another example, the basis by which the infrastructure system splits the one or more autonomous vehicles 300a-300d includes the proximity of the one or more autonomous vehicles 300a-300d in relation to the first RSU 308, the number of waypoints required for each autonomous vehicle of the one or more autonomous vehicles 300a-300d to be successfully marshaled, or a combination thereof. However, it is understood that any criteria may be utilized as a basis for the infrastructure system to split the one or more autonomous vehicles 300a-300d into the multiple groups. More specifically, the infrastructure system may split the one or more autonomous vehicles 300a-300d into the multiple groups by grouping autonomous vehicles nearest to the first RSU 308 as the first group 302 and the autonomous vehicles farther away (e.g., in comparison to the first group 302) from the first RSU 308 as the second group 304.

For example, FIG. 3A depicts an instance wherein the infrastructure system fragments an IMM intended for receipt by four (“4”) autonomous vehicles (e.g., the one or more autonomous vehicles 300a-300d) into two (“2”) fragmented messages. A first fragment of the fragmented messages can be sent to a single marshaled vehicle 300d (e.g., in the second group 304) that requires five (“5”) waypoints 306 to be successfully guided to a particular destination. A second fragment of the fragmented messages can be sent to a group of marshaled autonomous vehicles 300a-300c (e.g., in the first group 302) wherein each autonomous vehicle requires 2 waypoints 306 to be successfully guided to the particular destination. For example, the first group 302 and the second group 304 are established based on the distance of the one or more autonomous vehicles 300a-300d from the first RSU 308. As a particular example, the single marshaled vehicle 300d is farther from the first RSU 308 (e.g., 600 m from the first RSU 308) than each vehicle of the group of marshaled vehicles 300a-300c (e.g., 100 m from the first RSU 308). It is understood that the fragmented messages can be different sizes that are sent during the same (e.g., or different) transmission interval to marshal each of the one or more autonomous vehicles 300a-300d. It is also understood that the transmission interval(s) is dynamically defined based on feedback received from AVM infrastructure sensors (e.g., the one or more infrastructure sensors 110) associated with each of the first group 302 and the second group 304, in some examples. For example, the feedback may be associated with any of the autonomous vehicles' 300a-300d progression toward each of their respective waypoints based on the AVM infrastructure sensors' monitoring of the movement of each of the one or more autonomous vehicles 300a-300d.

FIG. 3B is illustrative of a second example embodiment related to one or more adjustments the infrastructure system makes to accommodate movement of the one or more autonomous vehicles 300a-300d within the environment. For example, as the one or more autonomous vehicles 300a-300d traverse the environment, each of the distances of the one or more autonomous vehicles 300a-300d from the first RSU 308 may change. Furthermore, due to nearby obstructions and/or objects, some of the autonomous vehicles of the one or more autonomous vehicles 300a-300d may require additional waypoints to accommodate tighter maneuvers (e.g., having more changes in direction in shorter distances). As the one or more vehicles 300a-300d traverse the environment and/or encounter any obstructions, the infrastructure system is configured to update the groupings (e.g., the first group 302, the second group 304 and a third group 310) of the one or more vehicles 300a-300d to maximize communication reliability. It is understood that the infrastructure system is also configured to update the groupings of the one or more vehicles 300a-300d to maximize any utility value. For example, one marshaled autonomous vehicle in a particular group may become part of another group of autonomous vehicles as the one marshaled autonomous vehicle maneuvers closer to the another group of autonomous vehicles.

As a particular example, the third group 310 is created to accommodate the additional waypoints 306 required to accommodate any additional maneuvers. For example, the autonomous vehicle 300a has moved farther away from the first RSU 308 but still requires 2 waypoints to be successfully guided to the particular destination and thus is placed in the third group 310. As another example, while the autonomous vehicles 300b and 300d have moved farther away from the first RSU 308, each of the autonomous vehicles 300b and 300d now require 4 waypoints to be successfully guided to the particular destination and thus are both placed in the first group 302. As a further example, the autonomous vehicle 300c has moved closer to the first RSU 308 but still requires 2 waypoints to be successfully guided to the particular destination and thus is placed in the second group 304. As such, vehicles requiring a same number of waypoints can be dynamically placed within or assigned to a particular group.

It is understood that to aid the infrastructure system in its decision-making associated with the optimization in the fragmentation of any IMMs, the infrastructure system is configured to first estimate the number of bytes that may be required to define one or more maneuver commands associated with each autonomous vehicle of the one or more autonomous vehicles (e.g., the one or more autonomous vehicles 300a-300d). The infrastructure system is then configured to create autonomous vehicle combinations to determine the optimal creation of the groups (e.g., the first group 302, the second group 304, and/or the third group 310). For example, optimizing the creation of the groups in various examples is performed to maximize the reception of the IMMs by each of the one or more autonomous vehicles. It is additionally understood that the count of IMMs generated per transmission interval and/or the autonomous vehicle(s) being guided associated with each IMM can be dynamically adjusted (e.g., adjusted at any time and in any way).

FIG. 3C is illustrative of a third example embodiment related to an instance wherein multiple RSUs (e.g., the first RSU 308 and a second RSU 312) are utilized by the infrastructure system to marshal the one or more autonomous vehicles 300a-300d. For example, with multiple RSUs in the environment, the segmentation (e.g., the division) of the autonomous vehicles 300a-300d may be based on grouping autonomous vehicle(s) based on vehicle proximity to a particular RSU. As another example, the various criteria used to segment the autonomous vehicles 300a-300d include, but are not limited to: a received signal strength of a vehicle message; an RSU range to any of the autonomous vehicles 300a-300d; a weighted utility based on an autonomous vehicle container byte size; a total count of marshaled autonomous vehicles that may be used by the infrastructure system to generate single and/or multiple IMMs per transmission interval that can change over time; or a combination thereof.

As a particular example, the second RSU 312 can be utilized to aid in the marshaling of the one or more autonomous vehicles 300a-300d. As a further example, the placement of multiple RSUs (e.g., the first RSU 308 and the second RSU 312) inside the environment is determined by a predicted path that the one or more autonomous vehicles will drive). As another example, curvy portions (e.g., or non-straight portions) of the predicted paths are supported by a nearby RSU (e.g., the second RSU 312) to use a single IMM for several autonomous vehicles (e.g., the autonomous vehicle 300b and the autonomous vehicle 300d) in close range to the nearby RSU (e.g., the second RSU 312). As yet another example, straight portions of the predicted path have smaller IMM sizes due to less waypoints required for transmission to the autonomous vehicles (e.g., the autonomous vehicle 300a and the autonomous vehicle 300c) and therefore can be positioned within a wider range relative to another RSU (e.g., the first RSU 308).

As a fourth example embodiment, varying IMM groupings and an associated IMM count per transmission interval associated with each of the IMM groupings may create a burden for the one or more autonomous vehicles (e.g., the one or more autonomous vehicles 300a-300d) to track marshaling guidance associated with each of the autonomous vehicles as each of the autonomous vehicles would have to track multiple IMMs instead of a single IMM, in this example instance. To minimize this load, any new IMM grouping may be impeded for a minimum interval (e.g., 5 seconds) so that tracking of the IMMs is more manageable. For example, in the instance wherein the infrastructure system does not receive one or more VMM(s) associated with a particular autonomous vehicle of the one or more autonomous vehicles within a certain interval, the infrastructure system may remove the particular autonomous vehicle associated with the non-receipt of the VMM(s) from the infrastructure system's IMM. However, in this particular example, the associated IMM is updated in the next transmission interval.

As another example, as the infrastructure system onboards new autonomous vehicles, the infrastructure system adds the newly onboarded autonomous vehicles into the infrastructure system's IMMs in the next transmission interval. As yet another example, the infrastructure system can also operate to maintain a maximum byte size of a maximum number of grouped autonomous vehicles within a IMM. The infrastructure system can also revert to keep a single IMM for each of the autonomous vehicles if the number of marshaled autonomous vehicles and/or the total byte size falls below a threshold. For example, the threshold can be associated with a number of marshaled autonomous vehicles and/or the total byte size associated with each of the marshaled autonomous vehicles.

As a fifth example embodiment, the infrastructure system can dynamically adjust the IMM groupings based at least on an autonomous vehicle's maneuver location. For example, if the autonomous vehicle is in a particular maneuvering zone, the infrastructure system can categorize the respective autonomous vehicle's messages as part of a high priority scheduling of the IMM fragmented message. As another example, if an autonomous vehicle is in a non-marshaling zone (e.g., a repair bay and/or other station(s)), the infrastructure system can categorize the respective autonomous vehicle's messages as part of a low priority scheduling of the IMM fragmented message. Thus, in both example instances, the infrastructure system is configured to send two IMMs with different downlink intervals using priority as a criterion instead of a single large IMM, for example. In one or more examples, the infrastructure system is configured to update the priority scheduling zones, actively and dynamically, for each of the autonomous vehicles so that any effects associated with a loss of wireless communication and/or unnecessary congestion triggering can be reduced. It is understood that the infrastructure system is configured to update the priority scheduling zones, actively and dynamically, for each of the autonomous vehicles so that any communication-related issues are be reduced.

It is understood that downlink IMM transmission periodicity can be adjusted to accommodate a large load. For example, it is possible to increase an inter-transmit interval associated with the IMM from 100 ms to 1000 ms for a batch of stationary autonomous vehicles. As an additional example embodiment, if the infrastructure system detects an overload due to a condition (e.g., one or more perilous conditions) such as, but not limited to, the unexpected presence of a plurality of humans moving into the AVM area, cameras being rendered non-functional, and/or inclement weather, the downlink system may remove certain or an appropriate number of autonomous vehicles from its guidance control. For example, the removed autonomous vehicles will come to a stop. As another example, the IMMs will thus omit the removed autonomous vehicles from guidance in order to maintain security in the marshaling process. It is understood, however, that once the condition is resolved, the removed autonomous vehicles can be re-onboarded to the infrastructure system. While numerous embodiments are described, it is understood that any aspect from any of the embodiments may be interchangeably applied within any particular embodiment.

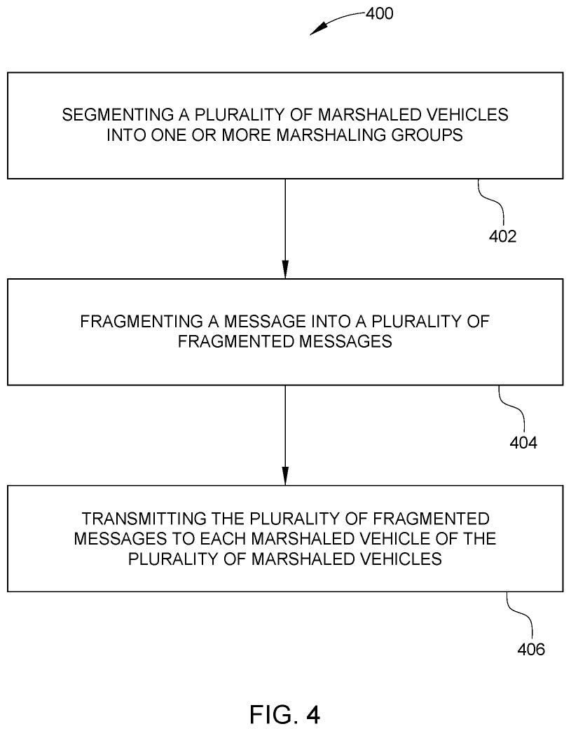

FIG. 4 is a flowchart illustrating an example method 400 for marshaling a plurality of autonomous vehicles (e.g., the one or more autonomous vehicles 102a-102e). At operation 402, a plurality of marshaled vehicles is segmented into one or more marshaling groups (e.g., the first group 302, the second group 304, or the third group 310). For example, the plurality of marshaled vehicles is segmented into one or more marshaling groups based on a distance each of the marshaled vehicles are from a respective road-side unit of one or more road-side units (e.g., the first RSU 308 or the second RSU 312). As another example, the plurality of marshaled vehicles is segmented, based at least in part on, a number of waypoints (e.g., the waypoints 306) associated with each of the marshaled vehicles. As an additional example, a process of the segmentation of the plurality of marshaled vehicles can include a generation of one or more marshaling group combinations. As yet another example, the generation of one or more marshaling group combinations is based on a determination of a number of bytes.

At operation 404, a message is fragmented into a plurality of fragmented messages. For example, the fragmentation of the message is based on one or more transmission criteria. As an example, a frequency of the transmission of the plurality of fragmented messages is adjustable based on the transmission criteria between a minimum and maximum value. The transmission frequency of IMMs and/or VMMs can be adjusted from 100 milliseconds inter-transmit time between the infrastructure system and the plurality of autonomous vehicles to 1000 milliseconds in a case wherein a distance between each of the autonomous vehicles has increased or in a case wherein the autonomous vehicles are not moving at all, for example. However, it is understood that the range for adjusting the transmission frequency of IMMs can be between any value representative of a minimum and maximum value. As another example, the one or more transmission criteria includes a distance each of the marshaled vehicles are from each road-side unit of the one or more road-side units, a number of marshaled vehicles of the plurality of marshaled vehicles, a number of waypoints associated with each of the marshaled vehicles, or a combination thereof. As yet another example, a process of the fragmentation of the message can include a determination of a number of bytes required to define one or more maneuver commands for each marshaled vehicle of the plurality of marshaled vehicles.

At operation 406, the plurality of fragmented messages is transmitted to each marshaled vehicle of the plurality of marshaled vehicles. For example, a first marshaling group (e.g., the first marshaling group 302) of the one or more marshaling groups receives a fragmented message that is different than a fragmented message received by a second marshaling group (e.g., the second marshaling group 304) of the one or more marshaling groups. As another example, the first marshaling group is disposed within a marshaling zone and the second marshaling group is disposed within a non-marshaling zone. As an additional example, a high-priority fragmented message is transmitted to the first marshaling group and a low-priority fragmented message is transmitted to the second marshaling group. For example, the AVM central server edge 104 can fragment the message(s) based on the one or more transmission criteria and transmit the plurality of fragmented messages to a marshaling group (e.g., the first marshaling group and/or the second marshaling group) as often as is necessary to marshal each of the marshaled vehicles successfully to a particular destination.

Thus, in some implementations, the following is provided: in AVM, the IMM is the message that a smart infrastructure (e.g., the infrastructure system) in a manufacturing plant or parking lot wirelessly transmits using C-V2X or some other short-range technology to autonomous vehicles that are being marshaled. Additionally, since smaller packet sizes allow for a longer communication range, in an AVM system, the smart infrastructure can aim to use smaller packets to increase reliable reception of the packets by the marshaled vehicles and thus have better downlink (e.g., RSU-to-AV) coverage. Further, when multiple or numerous automated vehicles are beings marshaled, each IMM that is broadcast within a transmission interval (e.g., typically every 100 milliseconds) may carry the guidance from the smart infrastructure to maneuver all the automated vehicles. The smart infrastructure may choose to instead fragment the large IMM for all the marshaled automated vehicles into multiple IMMs instead over the transmission interval. The reason for this is that the IMM packet size depends on the number of marshaled autonomous vehicles and the number of commanded trajectory waypoints. A larger IMM may be poorly received by a marshaled automated vehicle further away due to wireless factors such as large path loss. Upon receiving an IMM, an autonomous vehicle simply identifies the segment that contains waypoint commands for itself for maneuver guidance. As an additional example, the smart infrastructure can decide on how best to fragment the respective vehicles' container data depending on each vehicle's commanded maneuver. As yet another example, the fragmentation of a larger IMM into multiple smaller IMMs can result in range optimization and better system performance. As a further example, if multiple RSUs are used by the smart infrastructure, then these RSUs can be optimally positioned near locations where autonomous vehicles are likely to pass, thereby optimizing downlink coverage where each RSU may marshal a unique set of automated vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
segmenting a plurality of marshaled vehicles into one or more marshaling groups based on a distance each of the marshaled vehicles are from a respective road-side unit of one or more road-side units;
fragmenting a message into a plurality of fragmented messages based on one or more transmission criteria; and
transmitting the plurality of fragmented messages to each marshaled vehicle of the plurality of marshaled vehicles, wherein a first marshaling group of the one or more marshaling groups receives a fragmented message that is different than a fragmented message received by a second marshaling group of the one or more marshaling groups.

2. The method of claim 1, wherein the plurality of marshaled vehicles is segmented, based at least in part on, a number of waypoints associated with each of the marshaled vehicles.

3. The method of claim 1, wherein a frequency of the transmission of the plurality of fragmented messages is adjustable based on the one or more transmission criteria, and wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof.

4. The method of claim 1, further comprising:
updating the segmentation of the plurality of marshaled vehicles based on an updated distance each of the marshaled vehicles are from the respective road-side unit.

5. The method of claim 1, wherein the fragmentation of the message further comprises:
determining a number of bytes required to define one or more maneuver commands for each marshaled vehicle of the plurality of marshaled vehicles.

6. The method of claim 5, wherein the segmentation of the plurality of marshaled vehicles further comprises:
generating one or more marshaling group combinations based on the determination of the number of bytes.

7. The method of claim 1, wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.

8. A system comprising:
an infrastructure system configured to:
segment a plurality of marshaled vehicles into one or more marshaling groups based on a distance each of the marshaled vehicles are from a respective road-side unit of one or more road-side units,
fragment a message into a plurality of fragmented messages based on one or more transmission criteria, and
transmit the plurality of fragmented messages to each marshaled vehicle of the plurality of marshaled vehicles;
a first marshaling group configured to:
receive a fragmented message of the plurality of fragmented messages; and
a second marshaling group configured to:
receive a fragmented message of the plurality of fragmented messages that is different than the fragmented message received by the first marshaling group.

9. The system of claim 8, wherein the plurality of marshaled vehicles is segmented, based at least in part on, a number of waypoints associated with each of the marshaled vehicles.

10. The system of claim 8, wherein a frequency of the transmission of the plurality of fragmented messages is adjustable based on the one or more transmission criteria, and wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof.

11. The system of claim 8, wherein the infrastructure system is further configured to:
update the segmentation of the plurality of marshaled vehicles based on an updated distance each of the marshaled vehicles are from the respective road-side unit.

12. The system of claim 8, wherein the infrastructure system configured to fragment the message is further configured to:
determine a number of bytes required to define one or more maneuver commands for each marshaled vehicle of the plurality of marshaled vehicles.

13. The system of claim 12, wherein the infrastructure system configured to segment the plurality of marshaled vehicles is further configured to:
generate one or more marshaling group combinations based on the determination of the number of bytes.

14. The system of claim 8, wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.

15. One or more non-transitory computer-readable media storing processor-executable instructions that, when executed by at least one processor, cause the at least one processor to:
segment a plurality of marshaled vehicles into one or more marshaling groups based on a distance each of the marshaled vehicles are from a respective road-side unit of one or more road-side units and based on a number of waypoints associated with each of the marshaled vehicles;
fragment a message into a plurality of fragmented messages based on one or more transmission criteria; and
transmit the plurality of fragmented messages to each marshaled vehicle of the plurality of marshaled vehicles, wherein a first marshaling group of the one or more marshaling groups receives a fragmented message that is different than a fragmented message received by a second marshaling group of the one or more marshaling groups.

16. The one or more non-transitory computer-readable media of claim 15, wherein a frequency of the transmission of the plurality of fragmented messages is adjustable based on the one or more transmission criteria, and wherein the one or more transmission criteria include a distance each of the marshaled vehicles are from each road-side unit of the one or more road-side units, a number of marshaled vehicles of the plurality of marshaled vehicles, a number of waypoints associated with each of the marshaled vehicles, or a combination thereof.

17. The one or more non-transitory computer-readable media of claim 15, wherein the at least one processor is further caused to:
update the segmentation of the plurality of marshaled vehicles based on an updated distance each of the marshaled vehicles are from the respective road-side unit.

18. The one or more non-transitory computer-readable media of claim 15, wherein the processor-executable instructions that, when executed by the at least one processor, fragment the message, further causes the at least one processor to:
determine a number of bytes required to define one or more maneuver commands for each marshaled vehicle of the plurality of marshaled vehicles.

19. The one or more non-transitory computer-readable media of claim 18, wherein the processor-executable instructions that, when executed by the at least one processor, segment the plurality of marshaled vehicles, further causes the at least one processor to:
generate one or more marshaling group combinations based on the determination of the number of bytes.

20. The one or more non-transitory computer-readable media of claim 15, wherein the first marshaling group is disposed within a marshaling zone and the second marshaling group is disposed within a non-marshaling zone, and wherein a high-priority fragmented message is transmitted to the first marshaling group and a low-priority fragmented message is transmitted to the second marshaling group.
